(19) United States
(12) Patent Application Publication
(10) Pub. No.: US 2019/0371199 A1
(43) Pub. Date: Dec. 5, 2019

(54) System at least Comprising a Machine Tool, a Storage Device, and an External Unit

(71) Applicant: Robert Bosch GmbH, Stuttgart (DE)

(72) Inventors: Florian Bantle, Westerheim (DE); Thomas Duerr, Asperg (DE); Thomas Weller, Leinfelden-Echterdingen (DE); Jasamin Abied, Stuttgart (DE); Istvan Szell, Leinfelden-Echterdingen (DE)

(21) Appl. No.: 16/334,120

(22) PCT Filed: Aug. 23, 2017
(86) PCT No.: PCT/EP2017/071197

§ 371 Date: Mar. 18, 2019

(30) Foreign Application Priority Data
Sep. 19, 2016 (DE) 10 2016 217 837.7

(51) Int. Cl. G09B 19/00; B24B 23/00; B23B 45/00; B25F 5/00; B25H 3/02

(52) U.S. Cl. CPC G09B 19/003; B24B 23/005; B25D 17/00; B25F 5/00; B25H 3/02; B23B 45/00

(57) ABSTRACT

A system includes at least one first machine tool having at least one first receiving device for at least one insert tool, at least one storage device, and at least one external unit. The at least one insert tool is configured to be arranged on the at least one machine tool. The at least one storage device includes at least one second receiving device for the at least one insert tool. The at least one external unit has at least one external input interface. At least one application-specific parameter of at least one output is generated from an input, which is transmitted to the at least one machine tool, to the at least one storage device, and/or to other external units.

The invention relates to a system comprising at least a machine tool, a storage apparatus and an external device.

### PRIOR ART

### Disclosure of the invention

The system according to the invention having the features of the independent claim comprises at least one machine tool, at least one storage apparatus and at least one external device.

Advantageously, the machine tool has at least one first holding apparatus for at least one insert tool. Therefore, the insert tool can advantageously be arranged on at least one machine tool. The storage apparatus can be in the form of a toolbox. The storage apparatus can be used to store machine tools, associated insert tools and accessories. As an alternative to the toolbox design, the storage apparatus can be in the form of a trolley, in the form of a rucksack, in the form of a bag, in the form of a chest, in the form of a cardboard box or the like.

The machine tool can be a drill driver, a drill, a hammer drill, a screwdriver, an impact driver, a hammer drill, a demolition hammer, a sander, a plane, a milling cutter, a multicutter, a saw or the like. Insert tools can be: drills, screwdriver bits, sanding sheets, milling cutters, saw blades or the like.

The external device can be in the form of a smartphone, a tablet, a computer or an augmented reality device, such as augmented reality goggles.

The storage apparatus has at least one second holding apparatus for at least one insert tool, which means that the insert tool can be transported safely and conveniently separately from the machine tool.

At least one external device has at least one external input interface. The input of at least one application-specific parameter is used to generate at least one output that can advantageously be transmitted to at least one machine tool, at least one storage apparatus and/or at least one other external device. An application-specific parameter is intended in this case to be understood to mean in particular a material, a workpiece, a machining object, a weight of an object to be machined and/or a specific process step. Furthermore, it is conceivable for the application-specific parameter to be a type of an insert tool to be used, for example to be a drill, a saw blade or an abrasive.

Therefore, the system assists a user in carrying out the correct work steps in the correct order based on the application.

The features set out in the subclaims allow advantageous developments of the system according to the main claim.

Advantageously, the machine tool has at least one first input interface for at least one input of at least one application-specific parameter.

The machine tool has at least one first communication interface. Therefore, the machine tool can exchange at least one piece of information preferably bidirectionally, in particular preferably multidirectionally, with at least one storage apparatus, at least one external device and/or at least one other machine tool. Therefore, the application-specific parameter can advantageously be transmitted at least to the storage apparatus, the external device and/or other machine tools.

The machine tool preferably has at least one first output interface for presenting at least one piece of application-specific information. The information is therefore advantageously displayed or output to the user. The information can be visual, audible or haptic information. The at least one piece of user-specific information can be a work instruction, a status report, a warning or the like.

Advantageously, the storage apparatus has at least one second output interface for presenting at least one piece of application-specific information. Additionally, the storage apparatus has at least one second communication interface for a communication, preferably a bidirectional, in particular preferably a multidirectional, communication with at least one machine tool, an external device and/or other storage apparatuses.

Advantageously, the storage apparatus has at least one of the following components, the list not being conclusive:
a third holding apparatus for at least one external device
a fourth holding apparatus for at least one machine tool
a fifth holding apparatus for accessories

At least one second input interface for an input of at least one application-specific parameter is arranged on the storage apparatus.

Advantageously, the external device has at least the following components, the list not being conclusive:
an external input interface for inputting at least one application-specific parameter,
an external output interface for presenting at least one piece of application-specific information,
an external communication interface for bidirectional, preferably for multidirectional, communication with a machine tool, the storage apparatus and/or other mobile devices.

The cited advantages allow the system to provide situation-dependent advice and/or warnings. The system allows the user to easily find an optimum insert tool and/or accessories. The system specifically allows users with a lack or absence of knowledge about insert tools and accessories to select the right insert tool or accessories to perform the application successfully. The system makes it easier for the user to learn the application-specific process steps and speeds up learning progress. The system minimizes the potential for error and danger that can arise as a result of the incorrect selection or combination of insert tool and accessories. The system allows easy subsequent procurement of the correct insert tools and simple association and sorting into the storage apparatus.

Further advantages and expedient embodiments can be found in the description of the figures and in the drawings.

### DRAWINGS

The drawings show embodiments of a system according to the invention.

In the drawings:

FIG. 1 shows a system according to the invention having a machine tool, a storage apparatus and an external device in a schematic depiction,

FIG. 2 shows a second embodiment of the system according to the invention in a schematic depiction.

### DESCRIPTION

The same reference signs are used for the identical assemblies found in the different exemplary embodiments.

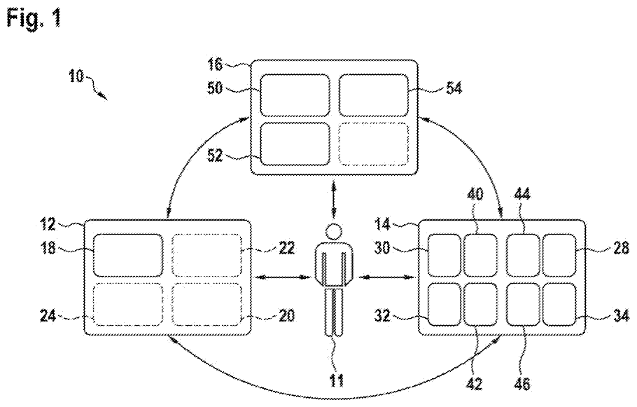

FIG. 1 shows a system 10 comprising a machine tool 12, a storage apparatus 14 for machine tools, associated insert tools and/or accessories and an external device 16. The system can be extended by:
further machine tools,
further storage apparatuses,
further external devices.

The machine tool 12 is intended to allow a user 11 an individual application. An individual application is for example the drilling of holes or the inserting of screws. In that case, the machine tool 12 should be a drill driver. The machine tool 12 can be a drill driver, a drill, a hammer drill, a screwdriver, an impact driver, a hammer drill, a demolition hammer, a sander, a plane, a milling cutter, a multicutter, a saw or the like.

The machine tool 12 has at least one first holding apparatus 18 for an insert tool 28 of the machine tool 12. Insert tools 28 can be: drills, screwdriver bits, sanding sheets, milling cutters, saw blades or the like.

Furthermore, the machine tool 12 has one or more first input interfaces 20. The first input interfaces 20 are used for the input of application-specific parameters by an operator of the machine tool 12.

The first input interfaces 20 can be for example keys, pushbuttons or other control elements.

The machine tool 12 has one or more first communication interfaces 22 for bidirectional or multidirectional communication with the storage apparatus 14 and/or the external device 16 and/or other machine tools.

The machine tool 12 has one or more first output interfaces 24. The first output interface 24 can be a loudspeaker, a display or the like. The first output interface 24 is used for presenting a piece of application-specific information such as for example a work instruction, a status report, a warning or the like.

Application-specific parameters are input into the machine tool 12 as an input by an operator 11 of the machine tool 12.

The machine tool 12 receives information such as for example application-specific parameters from the storage apparatus 14, the external device 16 and/or other machine tools. Received information is called an input in the present example.

The machine tool 12 sends information to the storage apparatus 14, to the external device 16 and/or to other machine tools. Sent information is called an output in the present example.

The display produced by the machine tool 12 can be a visual display and/or an audible signal and/or a haptic signal.

The storage apparatus 14 is intended to hold insert tools 28 for machine tools 12 for the storage and transport in order to make them available for use in the machine tool 12.

For this purpose, the storage apparatus 14 has a second holding apparatus 30 for an insert tool 28 in the machine tool 12.

Furthermore, the storage apparatus 14 has one or more second output interfaces 32. The second output interface can be a loudspeaker, a display or the like. The second output interface 32 is used for presenting a piece of application-specific information such as for example a work instruction, a status report, a warning or the like.

The storage apparatus 14 has one or more second communication interfaces 34 for bidirectional or multidirectional communication with the machine tool 12, the external device 16 and/or other storage apparatuses.

The storage apparatus 14 furthermore has at least one of the following components, the list not being conclusive:
a third holding apparatus 40 for at least one external device 16,
a fourth holding apparatus 42 for at least one machine tool 12,
a fifth holding apparatus 44 for further accessories, such as for example rechargeable batteries, at least one charger, consumables and the like.

The storage apparatus 14 can additionally have one or more second input interfaces. The second input interfaces are used for the input of application-specific parameters by an operator of the machine tool 12. The second input interfaces can be for example keys, pushbuttons or other control elements.

The storage apparatus 14 receives information such as for example application-specific parameters from the machine tool 12, the external device 16 and/or other storage apparatuses. Received information is called an input in the present example.

The external device 16 is intended to exchange information with the users, the machine tools and the storage apparatuses.

To this end, the external device 16 has one or more external input interfaces 50.

The external input interfaces 50 are used for the input of application-specific parameters by an operator of the machine tool 12. The external input interface 50 can be for example a touchscreen.

The external device 16 has one or more external output interfaces 52. The external output interface 52 is used for presenting a piece of application-specific information such as for example a work instruction, a status report, a warning or the like. The external output interface 52 can be a display or the like.

The external device 16 has one or more external communication interfaces 54 for bidirectional or multidirectional communication with a machine tool (12), the storage apparatus (14) and/or other mobile devices.

The external device 16 receives information such as for example application-specific parameters from the machine tool 12, the storage apparatus 14, other external devices and/or an operator. Received information is called an input in the present example.

The external device 16 sends information to the machine tool 12, to the storage apparatus 14 and/or to other external devices. Sent information is called an output in the present example.

The display produced by the external device 16 can be a visual display and/or an audible signal and/or a haptic signal.

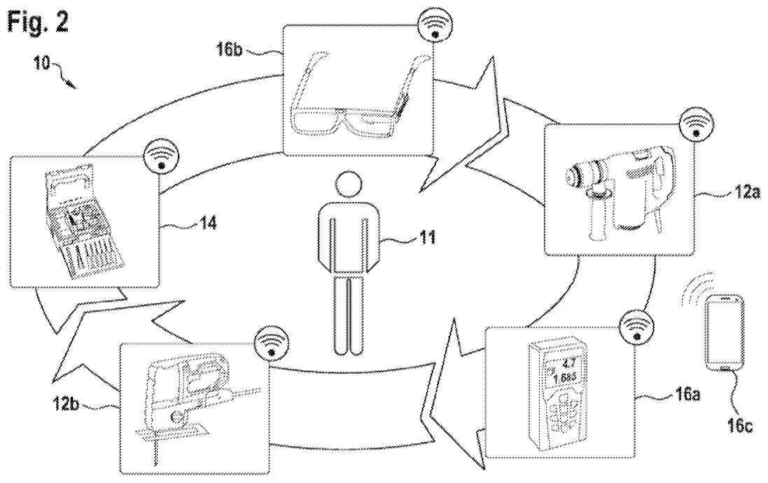

The system 10 in FIG. 2 comprises two machine tools 12a and 12b. The machine tool 12a is in the form of a rechargeable hammer drill and the machine tool 12b is in the form of a fret saw. The machine tools 12a and 12b are networked among one another.

The machine tools 12a and 12b have a built-in actuator system in order to be able to make for example mechanical adjustments automatically.

The storage apparatus 14 in the system 10 in FIG. 2 is a case in the form of a toolbox for insert tools 28 and/or accessories. The storage apparatus 14 is connective by means of a Bluetooth interface.

The system 10 in FIG. 2 comprises two external devices 16a and 16b. The external device 16a is in the form of an electronic measuring instrument and the external device 16b is in the form of augmented reality goggles (AR goggles). The external devices 16a, 16b are connective. A data processing unit is integrated in the AR goggles 16b. The data processing unit is a program running in the AR goggles. Alternatively, it is conceivable for the data processing unit to be integrated in the measuring instrument 16a.

A user 11 wears for example the AR goggles 16b on his head, carries a smartphone 16c on his body and/or in his pocket and has a toolbox 14 in his hand. In the embodiment according to the invention, the components AR goggles 16b, smartphone 16c and toolbox 14 are networked to one another and can communicate with one another.

1. A system comprising:
at least one first machine tool including at least one first holding apparatus configured to hold for at least one insert tool, wherein the at least one insert tool is configured to be arranged on the at least one first machine tool;
at least one storage apparatus including at least one second holding apparatus for the at least one insert tool; and
at least one external device including at least one external input interface,
wherein an input of at least one application-specific parameter is used to generate at least one output that is transmitted to the at least one first machine tool, the at least one storage apparatus, and/or to at least one other external device.

2. The system as claimed in claim 1, wherein the at least one application-specific parameter is a material, a workpiece, a machining object, a weight of an object to be machined, and/or a specific process step.

3. The system as claimed in claim 1, wherein the at least one first machine tool further includes at least one first input interface configured to receive the input of the at least one application-specific parameter.

4. The system as claimed in claim 1, wherein the at least one first machine tool further includes at least one first communication interface configured to communicate multidirectionally with the at least one storage apparatus, the at least one other external device, and/or other machine tools.

5. The system as claimed in claim 1, wherein the at least one first machine tool further includes at least one first output interface configured to present at least one piece of application-specific information.

6. The system as claimed in claim 5, wherein the at least one piece of application-specific information is a work instruction, a status report,. or a warning.

7. The system as claimed in claim 1, wherein the at least one storage apparatus includes at least one second output interface configured to present at least one other piece of application-specific information.

8. The system as claimed in claim 1, wherein the at least one storage apparatus includes at least one second communication interface configured to communicate multidirectionally with the at least one first machine tool, the at least one other external device, and/or other storage apparatuses.

9. The system as claimed in claim 1, wherein the at least one storage apparatus includes at least one of the following components (i) a third holding apparatus for at least one external device, (ii) a fourth holding apparatus for the at least one first machine tool, and (iii) a fifth holding apparatus for accessories.

10. The system as claimed in claim 1, wherein the at least one storage apparatus includes at least one second input interface configured to receive the input of the at least one application-specific parameter.

11. The system as claimed in claim 1, wherein the at least one external device includes an external input interface configured to input the at least one application-specific parameter, an output interface configured to present at least one piece of application-specific information, and an external communication interface configured to multidirectionally communicate with the at least one first machine tool, the at least one storage apparatus, and/or other mobile devices.

12. The system as claimed in claim 1, further comprising:
a mobile device configured to communicate with the at least one first machine tool and/or the at least one storage apparatus, the mobile device including a communication interface configured to multidirectionally communicate with the at least one first machine tool and/or the at least one storage apparatus.

13. (canceled)

14. (Canceled)
